(19) United States
(12) Patent Application Publication
(10) Pub. No.: US 2013/0142602 A1
(43) Pub. Date: Jun. 6, 2013

(54) Folding Mechanism and Power Supply for Lift Mounted to Vehicle

(71) Applicant: ROBBEY BARNTS, Diller, NE (US)

(72) Inventor: ROBBEY BARNTS, Diller, NE (US)

(21) Appl. No.: 13/311,141

(22) Filed: Dec. 5, 2011

(51) Int. Cl. B60P 1/02

(52) U.S. Cl. 414/462

(57) ABSTRACT

A battery-powered lift assembly includes a lift and a cam mounted to a vehicle hitch. The cam defines a substantially vertical finger notch and an angled finger notch. A biased folding bracket is pivotally coupled with the cam. A pallet is pivotally coupled with the lift and a cam follower is mounted to the pallet in a position to cooperatively interact with the folding bracket. When a load is on the pallet, the folding bracket yields to the cam follower permitting it to enter the substantially vertical finger notch and the pallet remains in a substantially horizontal position as the fill moves from a lowered position to a raised position. Without a load, the folding bracket directs the cam follower into the angled finger notch, which caused the pallet to pivot into a substantially vertical position. In this position, the cam may he tilted away from the vehicle hitch.

### CROSS-REFERENCE TO RELATED APPLICATIONS

Not Applicable.

### STATEMENT REGARDING FEDERALLY SPONSORED RESEARCH OR DEVELOPMENT

Not applicable.

### BACKGROUND OF THE INVENTION

Many motor vehicles are equipped with a hitch for towing campers or trailers. These hitches may also be, used to carry smaller storage devices such as a wheelchair or scooter lift. Storage devices free up internal vehicle space while traveling, but can be cumbersome to maneuver and require additional parking space. When in the towing position, these devices can also hinder access to a rear door or gate of the main motor vehicle. Often the storage container or carrier impedes movement Of such rear door or gate into an open position and must be removed from the vehicle hitch to permit access. Removing and reattaching the storage device is a time consuming and relatively physically intense procedure.

Many storage devices are motorized and must be wired into the vehicle's electrical system to power the motor that moves the device into various positions. Wiring a motorized storage device into the vehicle's electrical system can be complicated and expensive in that it requires electrical expertise and some disassembly of the vehicle. Hard wiring can also make removal and reattachment of the storage device to the vehicle hitch or transfer from one vehicle hitch to another more difficult and time consuming.

### BRIEF SUMMARY OF THE INVENTION

The present invention is directed to a lift assembly configured to be mounted to a vehicle hitch and used to transport a wheelchair, motorized scooter, or other load. The lift assembly has a lift that moves between a lowered position and a raised position and a platform or pallet on which a wheelchair, scooter or other loads can be positioned for transport. The lift assembly also includes a cam assembly that causes the pallet to pivot between a substantially horizontal and a substantially vertical position depending on the position of the lift and whether a load is placed on the pallet. When the lift is in the lowered position, the pallet is in a horizontal loading/unloading position adjacent to the ground. When a wheelchair, motorized scooter, or other load has been placed on the pallet for transport and the lift is in the raised position, the pallet is in a horizontal transport position substantially above the ground. When there is no load on the pallet and the lift is in the raised position, the pallet is in a substantially vertical storage position. In the storage position, the pallet and lift may optionally he tilted away from the vehicle hitch to permit access to a rear vehicle door or gate.

The cam assembly includes a cam having a substantially vertical linger notch and an angled finger notch, a cam follower mounted to the pallet, and a spring-biased folding bracket pivotally coupled with the cam. The cam follower cooperatively interacts with the folding bracket and the cam, which causes pallet to pivot as the lift is raised and lowered. When the pallet is loaded and the lift is raised, the folding bracket yields to the cam follower allowing it to enter the substantially vertical finger notch of the cam such that the pallet remains in the substantially horizontal position. When a load is not positioned on the pallet and the lift is raised, the folding bracket does not yield to the cam follower and, instead, guides the cam follower into the angled lingered notch of the cam. As the cam follower moves further into the angled notch, it causes the pallet to pivot from the substantially horizontal position to the substantially vertical position. When the lift is lowered, the opposite occurs in that the pallet gradually pivots from the substantially vertical position back to the substantially horizontal position as the cam follower leaves the angled finger notch.

Preferably, the lift is powered by a removable battery. Most preferably, the battery is a lightweight, rechargeable battery such as a lithium ion battery. The battery is releasably mounted to the lift such that it can easily be removed during transport or to prevent tampering when the lilt assembly is left unmonitored. The portable battery also eliminates the need to hardwire the lift to the vehicle, which allows a user to easily transfer the lift assembly from one vehicle to another.

Additional aspects of the invention, together with the advantages and novel features appurtenant thereto, will be set forth in part in the description which follows, and in part will become apparent to those skilled in the art upon examination of the following, or may he learned from the practice of the invention. The objects and advantages of the invention may be realized and attained by means of the instrumentalities and combinations particularly pointed out in the appended claims.

### BRIEF DESCRIPTION OF THE DRAWINGS

FIG. 1 is a perspective view of a lift assembly in accordance with a preferred embodiment of the present invention.

FIG. 2 is an exploded perspective. view of a portion of the lift assembly of FIG. 1, showing the cam and cam follower components.

FIG. 3 is a perspective view of a portion of the lift assembly of FIG. 1 showing the motor housing and upper section of the lift where a portion of the motor housing and lift has been cut away to show internal components and the battery is exploded out from the lift assembly.

FIGS. 4a-4c are side views of a portion of the lift assembly of FIG. 1 in the loading/unloading position, storage position, and transport position, respectively.

FIG. 5 is a perspective view of the lift assembly of FIG. 1 of the lift assembly in the transport position and carrying a load shown in phantom lines.

FIG. 6 is a perspective view of the lift assembly of FIG. 1 in the storage position.

FIG. 7 is a perspective view the lift assembly of FIG. 1 in the tilted position.

FIG. 8 is a perspective view of a battery charger and battery in accordance with a preferred embodiment of the present invention for use with a lift assembly.

### DETAILED DESCRIPTION OF PREFERRED EMBODIMENT

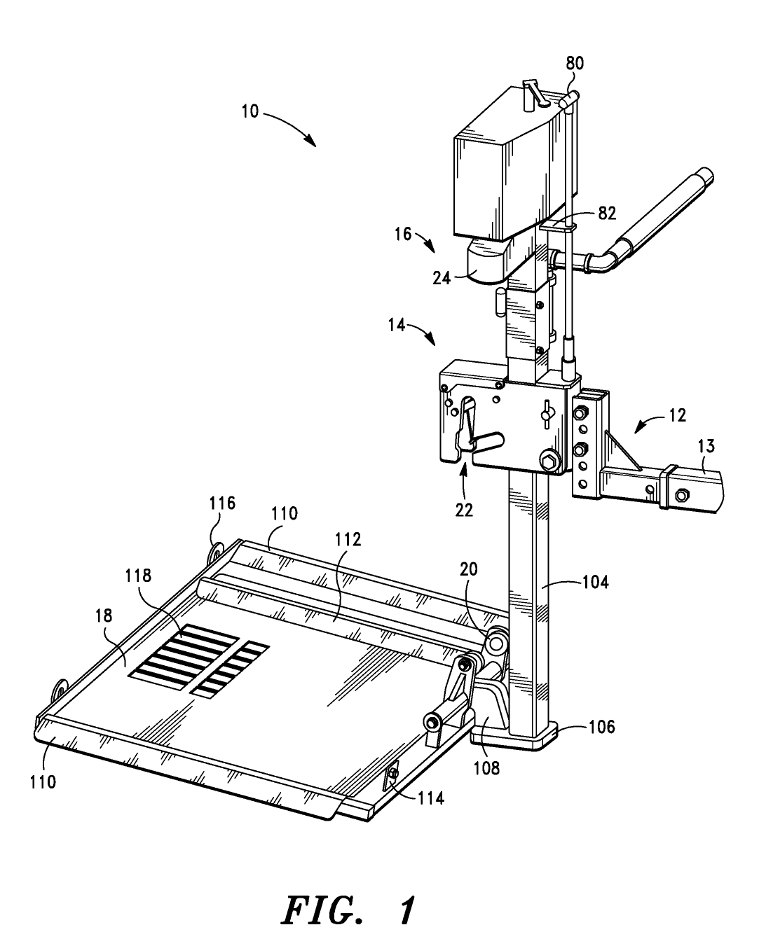

With reference to FIG. 1, a lift assembly in accordance with a preferred embodiment of the present invention is generally indicated by numeral 10. Lift assembly 10 includes a hitch mount 12 configured to be received by a vehicle hitch 13. A cam 14 is pivotally coupled with hitch mount 12 and a lift 16 is in turn coupled with cam 14. A pallet 18 is pivotally coupled with lift 16 and is configured to move between a substantially horizontal position and a substantially vertical position as lift 16 is raised and lowered. A cam follower 20 is rigidly attached to pallet 18 and positioned to cooperatively interact with cam 14 and a folding bracket 22 pivotally mounted to cam 14 as lift 16, powered by a battery 24, moves between a raised position and a lowered position, all as described in further detail below.

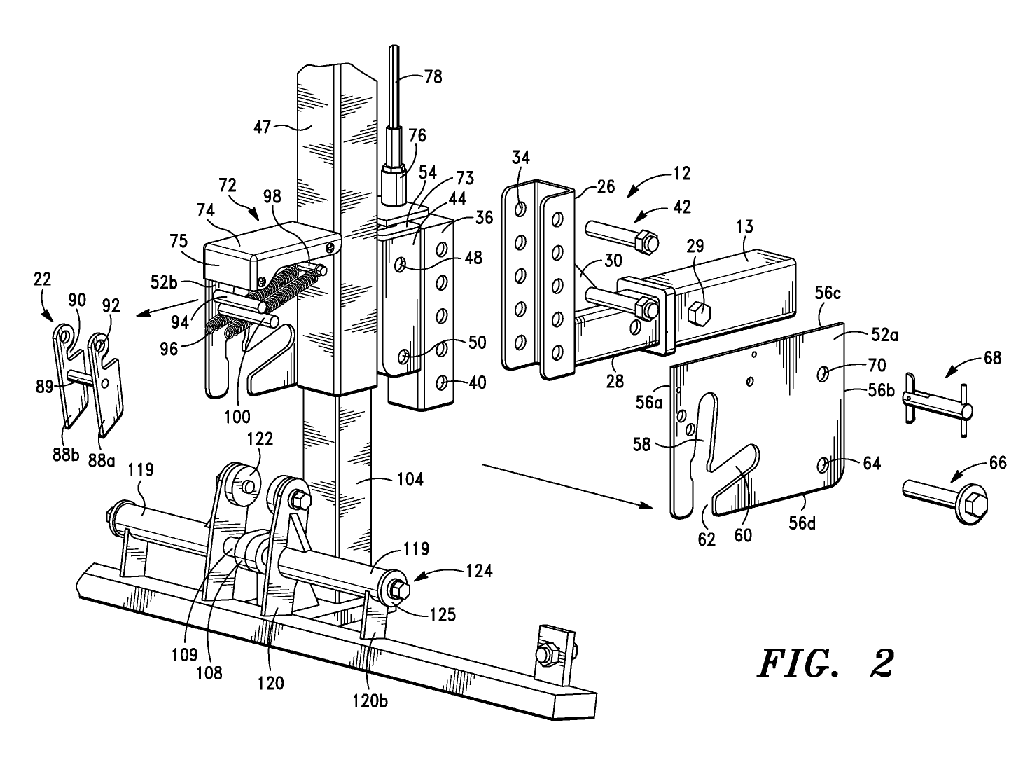

With reference to FIG. 2, hitch mount 12 has a vertical arm 26 and a horizontal arm 28. The rear end of horizontal arm, 28 is configured to be received by vehicle hitch 13 and has a substantially square cross-section. Horizontal arm 28 has one or more apertures on each side, which can be positioned to correspond with apertures on each side of vehicle bitch 13 such that a hitch pin 29 can be inserted to secure hitch mount 12 to vehicle hitch 13. Vertical arm 26, rigidly mounted to the front end of horizontal arm 28, extends above horizontal arm 28. A substantially triangular brace 30 is welded at the junction of vertical arm 26 and horizontal arm 28 to support vertical arm 26. Vertical arm 26 is U-shaped, having three sides 31a-c at approximately right angles to one another that collectively define a front opening 32. Rear side 31a is welded to the front end of horizontal arm 28 and triangular brace 30, left side 31h and right third side 31c face one another in a substantially parallel fashion and each include at least two apertures 34 in alignment with one another.

A first vertical support column 36 has a substantially square cross-section with four sides 38a-d and is configured to be received within opening 32 such that it can slide in a vertical direction. relative to vertical arm 26. Rear side 38a of first support column 36 contacts rear side 31a of vertical arm 26 when first support colimin 36 is poSitioned in-opening 32. Left side 38b and right side 38c of first support column 36 contact corresponding left side 31b and right side 31c of vertical arm 26, respectively, when first support column 36 is positioned within opening 32. Left side 38b and right side 38c of first support column 36 each define at least two apertures 40 corresponding with apertures 34 of vertical arm 26. First support column 36 is positioned within opening 32 of vertical arm 26 such that at least one set of apertures 40 in first support column 36 is aligned with one set of apertures 34 in vertical arm 26. First support column 36 and vertical arm 26 arc coupled together using removable fasteners 42. Preferably, removable fasteners 42 each comprise a bolt threaded through aligned apertures in first support column 26 and vertical arm 26 and secured using a nut on one side. The height of first support column 36 relative to vertical arm 26 can be adjusted by removing fasteners 42, vertically sliding first support column 36 in one direction to align a second set of vertical support apertures 40 with a set of apertures 34 in vertical arm 26, and re-inserting removable fasteners 42.

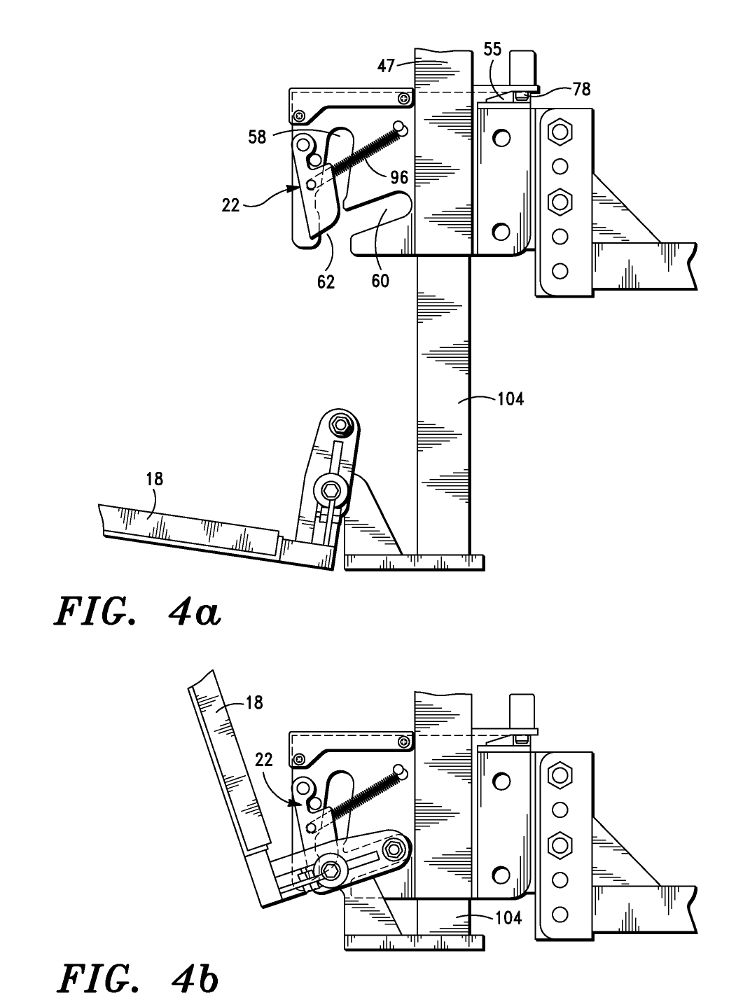

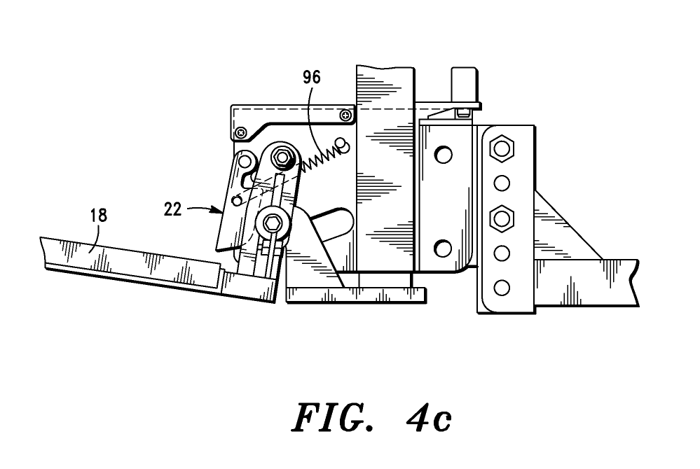

A second vertical support column 44 has a generally square cross-section and four sides 46a-d positioned at approximately rights angles to one another. Rear side 46a is welded to front side 38d of first support column 36. Rear side 46d of second support column 44 is welded to a stationary sleeve 47. Left side 46b and right side 46c of second support column 44 each define a top aperture 48 and a bottom aperture 50. Top aperture 48 and bottom aperture 49 are used to mount a pair of cam plates 52a and 52b described below. Second support column 44 also has top surface 54, which includes a wedge-shaped projection 55 (see FIG. 4a).

With further reference to FIG. 2, a first steel cam plate 52a and a second steel cam plate 52b are mounted on either side of stationary sleeve 47. Cam plates 52a and 52b are each generally rectangular in shape, having a front edge 56a, a rear edge 56b, a top edge 56c. and a bottom edge 56d. Each of cam plates 52a and 52b has a vertical finger notch 58 and an angular finger notch 60. Vertical finger notch 58 and angular finger notch 60 have a common entry channel 62 extending upward from bottom edge 56d. Preferably, vertical linger notch 58 angles away from front edge 56a and toward back edge 56b and bottom edge 56d at about an 8° angle. and angular finger notch 60 angles away from bottom edge 56d and toward top edge 56c and front edge 56a at about a 20° angle. Each of cam plates 52a and 52b are pivotally mounted to second support column 44 at an aperture 64 corresponding to bottom aperture 50 of second vertical support column 44 using an anchor fastener 66. Preferably, anchor fastener 66 is a bolt threaded through bottom apertures 50, buffered on one side with a washer and secured on the opposite side with a nut. A quick-release fastener 68 may he threaded through top aperture 48 and a corresponding aperture 70 in cam plates 52a and 52b to prevent the cam plates from pivoting: Preferably, quick release fastener 68 is a toggle pin.

Cam plates 52a and 52b are spaced apart and supported in parallel position relative to one another by saddle bracket 72 extending from the front side of stationary sleeve 47 and by top cover 73 extending from the rear side of stationary sleeve 47. Saddle bracket 72 has a relatively flat or planar top 74 with a peripheral skirt 75 extending downwardly from its side and front edges. Each of cam plates 52a and 52b is secured to portions of skirt 75 on each side of saddle bracket 72 using pop rivets. Saddle bracket 72 stabilizes cam plates 52a and 52b and ensures that vertical notch 58 and angular finger notch 60 of each plate are aligned.

Each of cam plates 52a and 52b is welded to the side edges of top cover 73. Top cover 73 has an aperture (not shown). A weld tapped collar 76 concentric with the aperture is mounted to the top surface of top cover 73. One end of a spring-biased handle rod 78 releasable extends downwardly through collar 76 and top cover 73 such that the bottom end of rod 78 is in abutting engagement with the rear surface of wedge projection 55. Handle rod 78 is biased in the engaged position to lock cam plates 52a and 52b, and thus stationary, sleeve 47 in place. As shown in FIG. 1, a top end of handle rod 78 extends above top cover 73 and is coupled with a handle 80. A stabilizing bracket 82 encircles handle rod 78 at approximately the midway point and is attached to Stationary sleeve 47. When handle rod 78 is pulled up using handle 80, handle rod 78 disengages from wedge projection 55 and cam plates 52a and 52b are permitted to pivot about anchor fastener 66 whereby stationary sleeve 47 tilts away from second vertical support column 44.

As shown in FIG. 2, folding bracket 22 is mounted beneath saddle bracket 72 and between cam plates 52a and 52b. Folding bracket 22 has a first and second arm 88a and 88b, which are held together by dowel 89. Each bracket arm includes a notch 90 and an aperture 92. The bottom edge or each bracket arm is slightly sloped such that the front bottom edge is lower than the rounded rear bottom edge. Folding bracket 22 is pivotally mounted between cam plates 52a and 52b such that bracket arms 88a and 88b pivot on a first front bar 94 that is threaded through apertures 92 and welded. on either end to cam plates 52a and 52b. Springs 96 are each attached at a first end to dowel 89 and anchored at a second end to a rear bar 98 extending between and welded on either end to cam plates 52a and 52b. Springs 96 bias folding bracket 22 to rest such that the lower end of arms 88a and 88b are positioned between vertical linger notch 58 of each cam plate (as shown in FIG. 1). A second front bar 100 extends between and is welded on either end to cam plates 52a and 52b and is positioned to be received into notch 90 when folding bracket 22 is biased by springs 96. In this manner, second front bar 100 prevents folding bracket 22 from being pulled by springs 96 past vertical finger notch 58. Springs 96 permit folding bracket 22 to pivot out from between vertical finer notches 58 and toward front edge 56a of cam plates 52a and 52b.

With further reference to FIG. 2, stationary sleeve 47 is welded to the front side of second vertical support column 44 such that the lower portion of the stationary sleeve is positioned between cam plates 52a and 52b. Stationary sleeve 47 is hollow and has a substantially square cross-section. A lifting column 104 is slidably housed within stationary sleeve 47 and moves between a lowered position and a raised position. As best shown in FIG. 1, a horizontal support 106, rigidly mounted to from the bottom of lifting column 104, extends forward from lifting column 104 to provide a mounting surface for a pair of attachment arms 108 mounted to and extending above horizontal support 106. Looking to FIG. 2, attachment arms 108 each include an aperture through which rod 109 extends. Rod 109 is solid and has a tapped hole in each end.

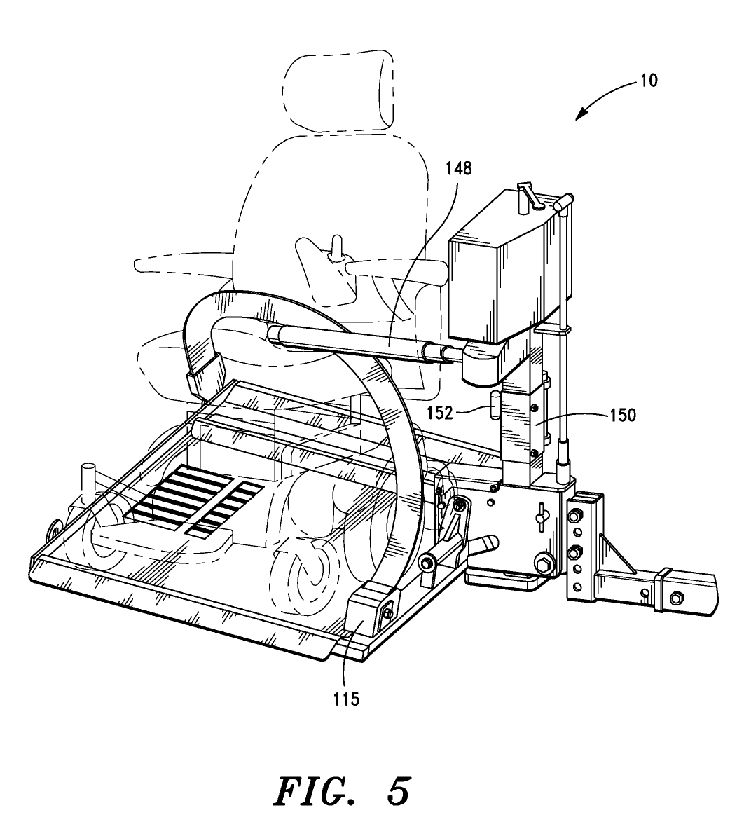

With reference back to FIG. 1, pallet 18 is substantially rectangular in shape having a relatively planar. upper surface and raised perpendicular edges. Preferably, pallet 18 includes ramped ends 110 for rolling a scooter or other load onto the pallet. To prevent a motorized scooter chair or other load from sliding, pallet 18 preferably has a non-slip surface and at least one adjustable wheel chock 112. Pallet 18 also has at least one belt projection 114 to Which a retractable belt assembly 115 (shown in FIG. 5) may be mounted. The free end of the retractable belt assembly may be secured to a loop 116 fixed on the opposite side of pallet 18. Pallet 18 also defines vents 118 to allow for drainage. As shown in FIG. 2, two horizontally extending tube segments 119 are each supported above one side of pallet 18 via inner and outer upright supports 120a and 120b. Knobs 122 secured to each inner upright support 120a are each positioned to be received into a corresponding vertical finger notch 58 or angular finger notch 60 in one of cam plates 52a and 52b when lifting column 104 is in the raised position. When assembled, rod 109 extends through tube segments 119, inner upright supports 120a, and attachment arms 108. Rod 109 is secured in place using a fastener 124 on each end. Preferably, fasteners 124 each include a threaded bolt, a washer, and an end cap 125. The end cap 125 has a circumference greater than the circumference of tube segments 119 and prevents rod 109 from pulling out of either end of tube segments 119 during use. Coupled to lifting column 104 in this manner, pallet 118 freely pivots from a substantially horizontal, perpendicular position to a substantially vertical, parallel position relative to lifting column 104.

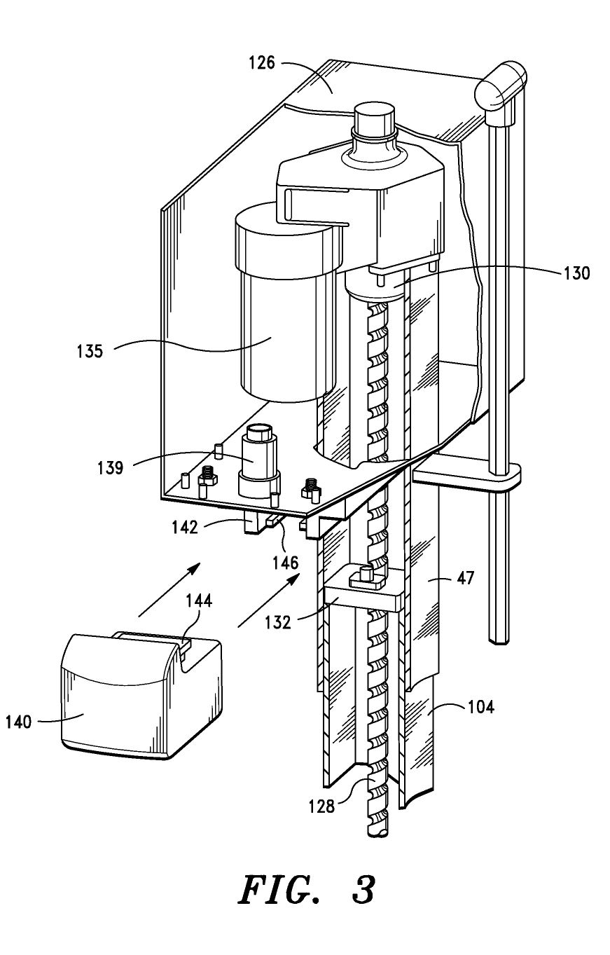

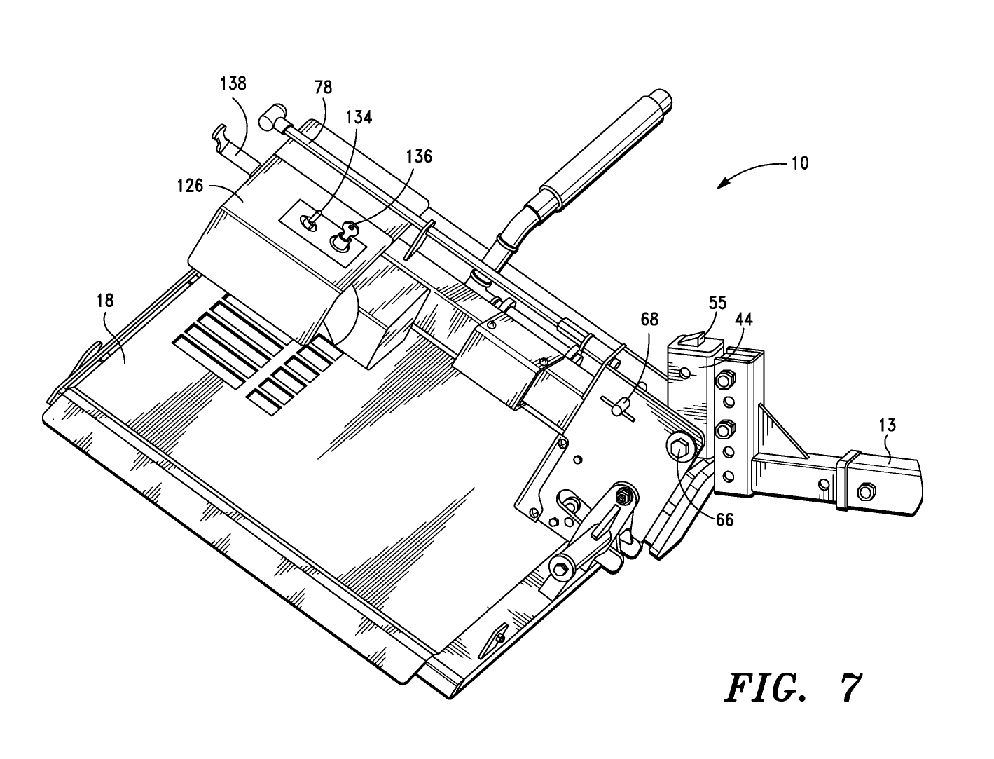

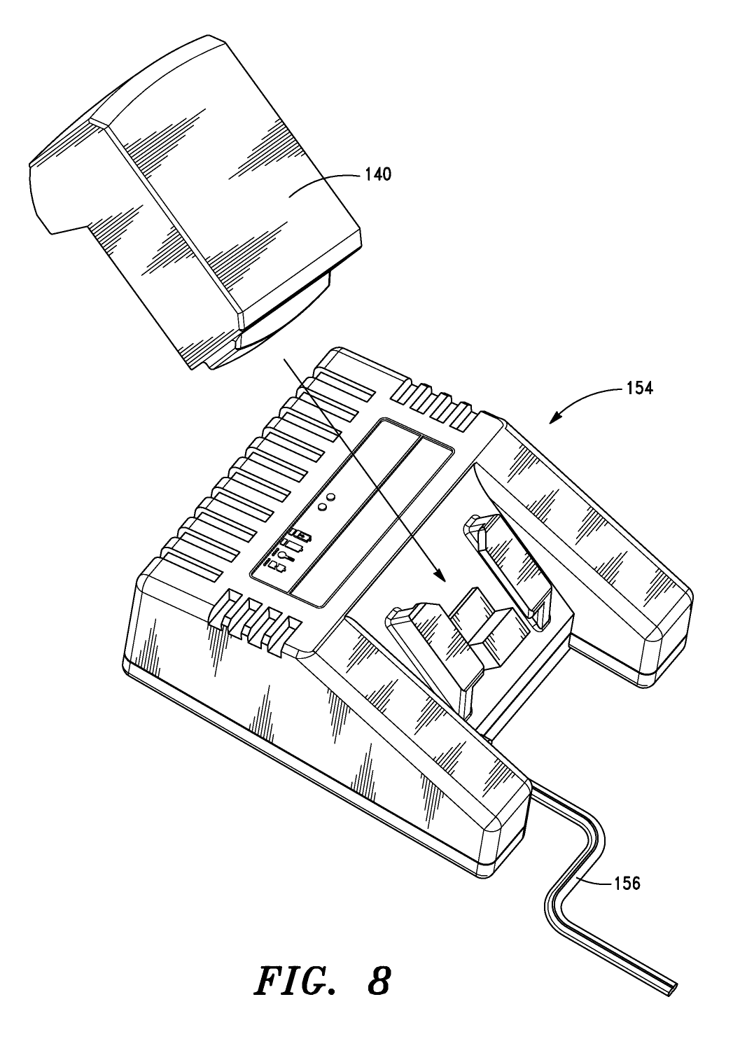

With reference to FIG. 3, a motor housing 126 attached at the upper end of stationary sleeve 47 is shown. A portion of stationary sleeve 47 is cut away to show lifting column 104 nested inside and the internal lifting mechanism. An elongated, threaded lift shall 128 is coupled with a worm gear 130. Worm gear 130 rotates lift shaft 128 alternatively in a first direction and then a second direction. A traveling piece 132 has an aperture counter-threaded to lift shaft 128. Traveling piece 132 is secured to the top edge of lifting column 104 such that when lift shaft is rotated in a first direction, traveling piece 132 moves down the shall thereby causing lifting column 104 to slide downward and extend out of the bottom of stationary sleeve 47 in the lowered position. When lift shaft 128 is rotated in a second direction, traveling piece 132 moves up the shaft there by causing lifting column to retreat inside stationary sleeve 47 in the raised position. The direction of rotation is controlled by a toggle control switch 134 (as shown in FIG. 7) accessible on the exterior of motor housing 126 that is operably connected to a motor 135. Motor 135 is Configured to power worm gear 130 and may be turned on/off by turning a power switch 136 (as shown in FIG. 7). Power switch 136 may be locked in the off position when the key is removed. Alternatively, a hand crank 138 (as shown in FIG. 1) is provided on the exterior of motor housing 126 and may be used to manually power worm gear 130.

A trailer wiring connector 139 is preferably provided on motor housing 126. A 4-pin round trailer type wiring connector is shown in FIG. 3 and configured to receive a wiring plug or harness to power a courtesy light on the front of motor housing 126 using the vehicle battery. The courtesy light may illuminate a license plate as required in some states. The wiring plug or harness may also power brake lights, turn signals, or running lights on lift assembly 10.

With further reference to FIG. 3, portable battery 140 is removably mounted to motor housing 126. When mounted battery 140 is operable to power motor 135 when power switch 136 is in the “on” position. Depending on the location of control switch 134, battery 140 powers motor 135, which drives worm gear 130 thereby rotating lift shaft 128 clock-wise or counter-clockwise. Battery 140 is mounted to motor housing 126 using a battery clip 142. Battery clip 142 is designed to guide battery 140 into a position where it is in electrical communication with motor 135 via power switch 136 and control switch 134 and to hold battery 140 in place during use. Battery 140 is coupled with battery clip 142 by sliding battery 140 in the direction of the arrows shown in FIG. 3 such that an upper plate 144 on battery 140 is received within clip 142 and supported along its bottom side edges by corresponding support flanges 146 extending within battery clip 142. Battery 140 may be removed by pulling it in the opposite direction. Battery 140 is preferably a rechargeable battery and most preferably a lithium battery.

Lift assembly 10 is shown in various positions during use in FIGS. 4a-4c, 5, 6, and 7. In FIGS. 4a-4c, one cam plate has been removed to show the position of folding bracket 22 and knobs 122 more clearly. Lift assembly 10 is shown in the loading/unloading position in FIG. 4a. In this position, lifting column 104 is in the lowered position and extends out of the bottom, of stationary sleeve 47 such that pallet 18 is adjacent to the ground. Handle rod 78 is engaged with wedge projection 55 to lock cam plates 52a and 52b and stationary sleeve 47 in place. Springs 96 hold folding bracket 22 in its biased position such that it blocks the entrance to vertical finger notch 58 but permits entry into angular finger notch 60 by way of common entry channel 62. Pallet 18 is in a substantially horizontal position. In this position, a load, such as a motorized scooter chair can be positioned on the pallet.

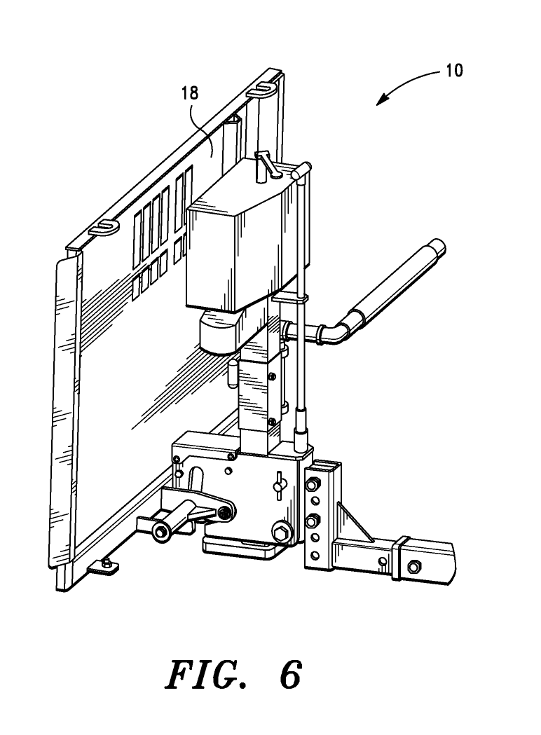

With reference to FIGS. 4b and 6, lift assembly 10 is not carrying a load and is in the storage position. As shown, lifting column 104 is in the raised position. As lifting column 104 moved from the lowered position shown in FIG. 4a to the raised position shown in FIG. 4b, knobs 122 entered common entry channel 62 in cam plates 52a and 52b. There, they encountered folding bracket 22. Because there was no load on pallet 18, folding bracket 22 was biased in its blocking position stronger than pallet 18 was biased in the horizontal position and knobs 122 were guided by the bottom edge of folding bracket 22 into angular finger notch 60. The torque exerted on pallet 18 by inner upright supports 120a as knobs 122 moved into the angular finger notches 60, caused pallet 18 to pivot about rod 109 into a substantially vertical position, as shown more fully in FIG. 6. In the storage position. lint assembly 10 can easily be transported by a motor vehicle without adding a significant amount of length to the vehicle. In this position, lift assembly 10 and the motor vehicle are also more easily parked and maneuvered in close quarters.

With reference to FIG. 4c, lift assembly 10 is carrying a load (not shown) and is in the transport position. As shown, lifting column 104 is in the raised position. As lifting column 104 moved from the lowered position shown in FIG. 4a to the raised position shown in FIG. 4c, knobs 122 entered the Common entry channel 62 in cam plates 52a and 52b. There they encountered folding bracket 22. Because the weight of the load biased pallet 18 in a horizontal position stronger than springs 96 biased folding bracket 22 in the blocking position, knobs 122 pushed folding bracket 22 out of the way and entered vertical timer notch 58. As more fully shown in FIG. 5, lift assembly 10 has a load, namely a motorized scooter chair, on pallet 18. In the preferred embodiment, a swinging arm 148 is provided to help stabilize the load. Swinging arm 148 is pivotally mounted to stationary sleeve 47 by arm bracket 150 and is permitted to swing between a stored position (as shown in FIG. 1) and a support position (as shown in FIG. 5). Swinging arm 148 is releasably locked in its stored position or its support position by lock mechanism 152. Lock mechanism 152 is pulled away from stationary sleeve 47 to release swinging arm 148. In its support position, swinging arm 148 exerts a downward pressure on the seat of the motorized scooter when lifting column 104 is in the raised position.

As shown in FIG. 7, lift assembly 10 is in the tilted position. As described with reference to FIGS. 4b and 6, lifting column 104 is in the raised position and pallet 18 is in the substantially vertical position. To move from the storage position shown in FIG. 6 to the tilted position shown in FIG. 7, quick release fastener 68 is temporarily removed and handle rod 78 is disengaged from wedge projection 55 to allow cam plates 52a and 52b to pivot about anchor fastener 66. In this manner, cam plates 52a and 52b, and thus stationary sleeve 47, lifting Column 104 and pallet 18, were permitted to tilt forward away from second vertical support. column 44. In this position, lift assembly 10 provides access to a rear vehicle door or gate without removing lift assembly 10 from vehicle hitch 13.

In the preferred embodiment, a battery charger 154, as shown in FIG. 8, is also provided. Battery charger 154 is configured to accept battery 140 in a similar manner to battery clip 142. Battery 140 May be coupled with battery charger 154 by sliding battery 140 in the direction of the arrows shown in FIG. 8. When coupled, battery charger 154 and battery 140 are in electrical communication such that when battery charger 154 is connected to a power supply (not shown) using cord 156, battery 140 is recharged. Battery 140 is preferably relatively small and portable such that it can easily be removed from lift assembly 10 and connected to battery charger 154. Battery 140 can easily be charged at home or at other locations. Most preferably, battery 140 is a lithium ion battery. Use of a rechargeable battery 140 to power lift assembly 10 eliminates the need for hard wiring to the vehicle electrical system. Having a self-contained power system means lift assembly 10 is easily moved from one vehicle to another without any advance wiring preparation. Battery 140 may also be removed during transport or when lift assembly is left unattended to prevent tampering.

While specific embodiments have been shown and discussed, various modifications may of course be made, and the invention is not limited to the specific forms or arrangement of parts and steps described herein, except insofar as such limitations are included in the following claims. Further, it will be understood that certain features and subcombinations are of utility and may be employed without reference to other features and subcombinations. This contemplated by and is within the scope of the claims.

What is claimed and desired to he secured by Letters Patent is as follows:

1. A lift assembly for carrying a load, wherein said lift assembly is configured to be mounted to a vehicle hitch, said lift assembly comprising:
a cam having a substantially vertical finger notch and an angled finger notch;
a lift coupled with said cam and configured to move between a lowered position and a raised position;
a pallet pivotally coupled with said lift and configured to pivot between a substantially horizontal position and a substantially vertical position;
a spring biased folding bracket pivotally coupled with said cam; and
a cam follower rigidly mounted to said pallet, wherein said cam follower and said folding bracket are configured to cooperatively interact such that said folding bracket yields to said cam follower when a load is on said pallet thereby permitting said cam follower to enter said substantially vertical finger notch as said lift moves from said lowered position to said raised position and said pallet remains in said substantially horizontal position and such that said folding bracket directs said cam follower into said angled finger notch as said lift moves from said lowered position to said raised position when a load is not on said pallet thereby causing said pallet to pivot into said substantially vertical position.

2. The lift assembly of claim 1, further comprising a tilt support, wherein said cam is pivotally coupled with said vertical support and is configured to pivot away from said vertical support.

3. The lift assembly of claim 2, further comprising a lock configured to prevent said cam from pivoting away from said vertical support and releasable to permit said cam to pivot away from said vertical support.

4. The lift assembly of claim 1, wherein said lift comprises a lifting column and a lifting mechanism and said pallet pivotally coupled with said lifting column.

5. The lift assembly of claim 4, wherein said lifting mechanism comprises a worm gear, a lift shaft, and a traveling piece secured to said lifting column.

6. The lift assembly of claim 1, further comprising a removable battery configured to power said lift.

7. The lift assembly of claim 1, further comprising a hand crank configured to power said said lift.

8. The lift assembly claim 1, further comprising an arm rotatably mounted to said lift and configured to rotate between a support position over said pallet and a storage position, wherein said arm contacts a load on said pallet when said lift is in said raised position and said arm is in said support position.

9. The lift assembly of claim 1, further comprising a pair of retractable restraints mounted to said pallet, each of said restraints having an anchored end secured to said pallet and a fastener end configured to be removably secured to said pallet.

10. A lift assembly for carrying a load, wherein said lift assembly is configured to be mounted to a vehicle hitch, said lift assembly comprising:
a hitch mount configured to be received by the vehicle hitch;
a cam mounted to said hitch mount, said cam comprising a substantially vertical finger notch and an angled linger notch;
a stationary sleeve mounted to said cam;
a lifting column configured to move between a raised position and a lowered position relative to said stationary sleeve;
a pallet pivotally coupled with said lifting column, wherein said pallet pivots between a substantially horizontal position and a substantially vertical position;
a spring-biased folding bracket pivotally coupled with said cam;
a cam follower rigidly mounted to said pallet, wherein said cam follower and said folding bracket are configured to cooperatively interact such that said folding bracket yields to said cam follower when a load is on said pallet thereby permitting said cam follower to enter said substantially vertical finger notch as said lifting column moves from said lowered position to said raised position and said pallet remains in said substantially horizontal position and such that said folding bracket directs said cam follower into said angled linger notch as said lifting column moves from said lowered position to said raised position when a load is not on said pallet thereby causing said pallet to pivot into Said substantially vertical position.

11. The lift assembly of claim 10, wherein said cam is pivotally mounted to said hitch mount and is configured to tilt away from said hitch mount.

12. The lift assembly of claim 11, further comprising a lock configured to prevent said cam from pivoting away from said hitch mount and releasable to permit said cam to pivot away from said hitch mount.

13. The lift assembly of claim 10, further comprising a removable battery configured to power said lift.

14. The lift assembly of claim 10, further comprising a hand crank configured to power said lift.

15. The lift assembly of claim 10, further comprising an arm rotatably mounted to said stationary sleeve and configured to rotate between a support position over said pallet and a storage position, wherein said arm contacts a load on said pallet when said liking column is in said raised position and said arm is in said support position.

16. The lift assembly of claim 10, further comprising a pair of retractable restraints mounted to said pallet, each of said restraints having an anchored end secured to said pallet and a fastener end configured to be removably secured to said pallet.

17. A lift assembly for carrying a load, wherein said lift assembly is configured to be mounted to a vehicle hitch, said lift assembly comprising:
a lifting column configured to move between a raise position and a lowered position;
a pallet coupled with said lifting column,
a motor operable to raise and lower said lifting column; and
a battery removably mounted to said motor and configured to power said motor when mounted.

18. The lift assembly of claim 17, further comprising a motor housing, wherein said battery is removably mounted on the exterior of said housing.

19. The lift assembly of claim 17, wherein said battery is a lithium battery.

20. The lift assembly of claim 17, further comprising a screw, jack configured to raise and lower said lifting column, wherein said motor drives said screw jack.
